(19) United States
(12) Patent Application Publication
(10) Pub. No.: US 2022/0306426 A1
(43) Pub. Date: Sep. 29, 2022

(54) SMOOTH BRAKING CONTROL METHOD AND DEVICE FOR ELEVATOR AND ELEVATOR BRAKE

(71) Applicant: Otis Elevator Company, Farmington, CT (US)

(72) Inventor: Guosong Li, Tianjin (CN)

(21) Appl. No.: 17/525,124

(22) Filed: Nov. 12, 2021

(30) Foreign Application Priority Data
Mar. 26, 2021 (CN) 202110326091.8

(51) Int. Cl. B66B 1/32; B66B 1/34; B66D 5/30; B66B 5/18

(52) U.S. Cl. CPC B66B 1/32; B66B 1/3407; B66B 1/3461; B66D 5/30; B66B 5/18

(57) ABSTRACT

A smooth braking control method for an elevator, a smooth braking control device for an elevator, and an elevator brake. The elevator is provided with an elevator brake including a fixed part and a moving part, and in a first state, by driving the moving part to move toward an elevator power device so that a friction member in the moving part contacts the elevator power device, the elevator brake provides a braking force to stop an elevator car, and in a second state, by outputting an electromagnetic force from an electromagnetic member in the fixed part, the friction member is disengaged from the contact with the elevator power device.

### FOREIGN PRIORITY

This application claims priority to Chinese Patent Application No. 202110326091.8, filed Mar. 26, 2021, and all the benefits accruing therefrom under 35 U.S.C. § 119, the contents of which in its entirety are herein incorporated by reference.

### TECHNICAL FIELD

The present disclosure relates to the technical field of elevators, and in particular to a smooth braking control method for an elevator, a smooth braking control device for an elevator, and an elevator brake.

### BACKGROUND

An elevator brake is a safety braking device in an elevator. It plays an important role in ensuring a safe operation of the elevator and the personal safety of passengers. An existing elevator system 100 is shown in FIG. 1. Generally, devices such as an elevator power device 20 (e.g., a traction machine and the like), an elevator brake 10, etc., may be arranged in an elevator machine room 400, and the elevator power device 20 is connected to an elevator car 200 through a rope 300 so as to provide power to the elevator car 200 so that the elevator car 200 is driven to move up and down in an elevator hoistway, and to stop at the passenger's target floor by operating the elevator brake, such as Fa, Fb or Fc, etc., shown in FIG. 1. In addition, in the event of an elevator failure, emergency accident, etc., the elevator car can also be safely braked through the elevator brake.

As shown in FIG. 2, typically, the elevator brake mainly includes a fixed part 1 and a moving part 2 which is capable of moving relative to the fixed part 1 according to operational requirements. The fixed part 1 may be fixedly installed in the elevator machine room 400, and a force F1 is provided by a component 5 (such as a spring, etc.) arranged between the fixed part 1 and the moving part 2 to drive the moving part 2 to move in a direction away from the fixed part 1, so that a friction member 4 located on the moving part 2 is enabled to contact a braking member 6 (such as a rotating wheel, a turntable, etc.) associated with the elevator power device 20 and that a braking force is provided, thereby making the elevator power device 20 stop outputting power to achieve the purpose of safe braking of the elevator car. In addition, an electromagnetic force F2 in an opposite direction to the force F1 may also be applied by means of an electromagnetic member 3 located at the fixed part 1 to urge the moving part 2 to move in a direction toward the fixed part 1, thereby disengaging the friction member 4 from the contact with the elevator power device 20, so that the power output of the elevator power device 20 is restored and the elevator car can operate again.

During use of the elevator, special circumstances such as those requiring rescue operations may occur, e.g., emergency stop of the elevator car, brake hard stop, etc., which are mostly caused by lack of electricity, device failure, parts damage in the elevator system, user's misoperations and the like. Such circumstances will cause uncomfortable effects on the passengers in the elevator car, and even lead to safety problems. For example, sometimes, some passengers may fall in the elevator car and may have parts such as knees and wrist joints injured, and accidents such as collision and bleeding, human trampling and the like may even be caused. In addition, when the vibration amplitude and the impact force of the elevator car are large, they may affect the human heart and other organs, or in severe cases, may even result in psychological disorders and other problems. The above problems may bring particularly high risks to the elderly, pregnant women, children, and sick people, and will lead to unfavorable situations such as passenger complaints, damage compensation, etc.

### SUMMARY

In view of the foregoing, the present disclosure provides a smooth braking control method for an elevator, a smooth braking control device for an elevator, and an elevator brake, so as to solve or at least alleviate one or more of the above problems and other problems in the prior art.

Firstly, according to an aspect of the present disclosure, a smooth braking control method for an elevator is provided, in which the elevator is provided with an elevator brake including a fixed part and a moving part; in a first state, by driving the moving part to move toward an elevator power device so that a friction member in the moving part contacts the elevator power device, the elevator brake provides a braking force to stop an elevator car, and in a second state, by outputting an electromagnetic force from an electromagnetic member in the fixed part, the friction member is disengaged from the contact with the elevator power device; the smooth braking control method for the elevator including the following steps: judging whether the elevator car is in a decelerating state according to current running characteristics of the elevator car; obtaining a current deceleration of the elevator car if it is determined that the elevator car is in the decelerating state; and judging whether the obtained current deceleration exceeds a preset value, and controlling a magnitude of the electromagnetic force output from the electromagnetic member if the obtained current deceleration exceeds the preset value, so that the deceleration of the elevator car is not larger than the preset value.

Optionally, the smooth braking control method for the elevator according to the present disclosure further includes the following step: setting a target deceleration of the elevator car, and controlling the magnitude of the electromagnetic force so that the deceleration of the elevator car is substantially maintained at the target deceleration, the target deceleration being no larger than the preset value.

In the smooth braking control method for the elevator according to the present disclosure, optionally, an input signal of the electromagnetic member is determined through closed-loop control based on a difference between the target deceleration and the obtained current deceleration of the elevator car, so that the electromagnetic member outputs the electromagnetic force of a corresponding magnitude according to the input signal.

Optionally, the smooth braking control method for the elevator according to the present disclosure further includes the following step: limiting the input signal within a preset range, before the input signal determined through the closed-loop control is input to the electromagnetic member.

In the smooth braking control method for the elevator according to the present disclosure, optionally, the closed-loop control includes PID control, and at least one of P, I, and D in the PID control is adjusted, in which a feedback signal in the PID control is a deceleration obtained by performing differential processing on a running speed of the elevator car, a command signal is the target deceleration, and the input signal includes a current signal and a voltage signal.

In the smooth braking control method for the elevator according to the present disclosure, optionally, the electromagnetic member is one or more winding coils arranged in a circumferential direction of the fixed part, and the magnitude of the electromagnetic force output from the electromagnetic member is controlled by controlling an input current or an input voltage of at least one of the winding coils.

Optionally, the smooth braking control method for the elevator according to the present disclosure further includes the following step: storing report information locally in the elevator or in a cloud server and/or sending the report information to a user end, the report information at least including the obtained deceleration data of the elevator car, and the user end including a mobile communication terminal of a user.

In addition, according to another aspect of the present disclosure, a smooth braking control device for an elevator is also provided, in which the elevator is provided with an elevator brake including a fixed part and a moving part; in a first state, by driving the moving part to move toward an elevator power device so that a friction member in the moving part contacts the elevator power device, the elevator brake provides a braking force to stop an elevator car, and in a second state, by outputting an electromagnetic force from an electromagnetic member in the fixed part, the friction member is disengaged from the contact with the elevator power device; the smooth braking control device for the elevator including a controller which is configured to execute the following steps: judging whether the elevator car is in a decelerating state according to current running characteristics of the elevator car; obtaining a current deceleration of the elevator car if it is determined that the elevator car is in the decelerating state; and judging whether the obtained current deceleration exceeds a preset value, and controlling a magnitude of the electromagnetic force output from the electromagnetic member if the obtained current deceleration exceeds the preset value, so that the deceleration of the elevator car is not larger than the preset value.

In the smooth braking control device for the elevator according to the present disclosure, optionally, the controller is further configured to execute the step of: according to a set target deceleration of the elevator car, controlling the magnitude of the electromagnetic force so that the deceleration of the elevator car is substantially maintained at the target deceleration, the target deceleration being no larger than the preset value.

In the smooth braking control device for the elevator according to the present disclosure, optionally, the controller is configured to: determine an input signal of the electromagnetic member through closed-loop control based on a difference between the target deceleration and the obtained current deceleration of the elevator car, so that the electromagnetic member outputs the electromagnetic force of a corresponding magnitude according to the input signal.

In the smooth braking control device for the elevator according to the present disclosure, optionally, the controller is further configured to execute the step of: limiting the input signal within a preset range, before the input signal determined through the closed-loop control is input to the electromagnetic member.

In the smooth braking control device for the elevator according to the present disclosure, optionally, the closed-loop control includes PID control, and at least one of P, I, and D in the PID control is adjusted, in which a feedback signal in the PID control is a deceleration obtained by performing differential processing on a running speed of the elevator car, a command signal is the target deceleration, and the input signal includes a current signal and a voltage signal.

In the smooth braking control device for the elevator according to the present disclosure, optionally, the electromagnetic member is one or more winding coils arranged in a circumferential direction of the fixed part, and the controller is configured to: control the magnitude of the electromagnetic force output from the electromagnetic member by controlling an input current or an input voltage of at least one of the winding coils.

In the smooth braking control device for the elevator according to the present disclosure, optionally, the controller is further configured to execute the step of: storing report information locally in the elevator or in a cloud server and/or sending the report information to a user end, the report information at least including the obtained deceleration data of the elevator car, and the user end including a mobile communication terminal of a user.

In addition, according to further another aspect of the present disclosure, an elevator brake is also provided, which is configured with the smooth braking control device for the elevator as described in any one of the above items.

From the following detailed description combined with the accompanying drawings, the principles, features, characteristics and advantages of the technical solutions according to the present disclosure will be clearly understood. For example, the present disclosure can eliminate or effectively alleviate the defects and problems arising when performing the brake hard stop operation on the elevator car in the prior art, and realize the smooth braking control of the elevator car, which therefore not only improves people's experience of taking the elevator, satisfaction and the safety of taking the elevator, but also helps further improve the functions of existing elevator brakes and perfect the performance of the elevator system. The present disclosure is easy to implement and has significant effects, so it has very high application value.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structural configurations described herein, and are not required to be drawn to scale.

FIG. 1 is a schematic structural view of an existing elevator system, in which an example of an elevator power device and an example of an elevator brake are shown at the same time.

FIG. 2 is a schematic view of a basic structure and working principle of an existing elevator brake.

FIG. 3 is a schematic flowchart of an embodiment of a smooth braking control method for an elevator according to the present disclosure.

FIGS. 4(a) and 4(b) simultaneously show, for the same elevator system by contrast, respective curves of running speed of an elevator car when a brake hard stop operation is performed on the elevator car by using the prior art and when a braking operation is performed on the elevator car by using an embodiment of the smooth braking control method for the elevator according to the present disclosure, respectively.

FIG. 5 is a schematic block diagram illustrating the working principle when PID control is applied in an embodiment of the smooth braking control method for the elevator according to the present disclosure.

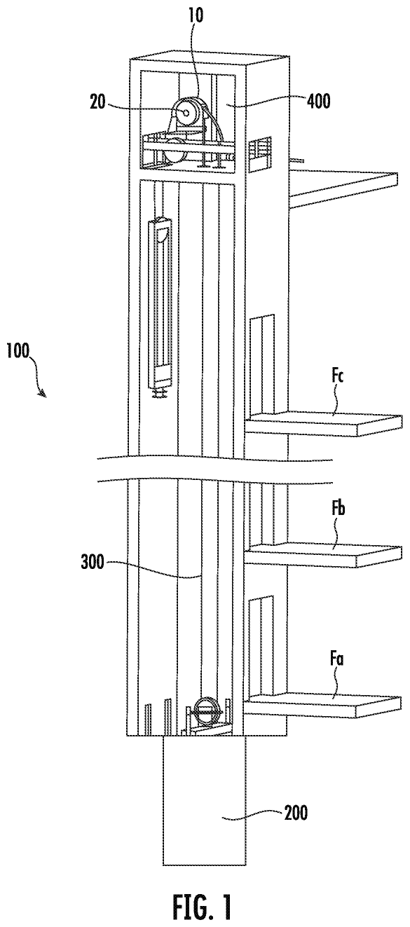

### DETAILED DESCRIPTION OF THE EMBODIMENT(S) OF THE INVENTION

First, it should be noted that the steps, components, characteristics, advantages and the like of the smooth braking control method for an elevator, the smooth braking control device for an elevator, and the elevator brake according to the present disclosure will be described below by way of example. However, it should be understood that neither of the descriptions should be understood as limiting the present disclosure in any way. In this document, the technical term “substantially” is intended to include non-substantive errors associated with the measurement of a specific parameter; for example, it may include a range consisting of a set value and ±8%, ±5%, or ±2% thereof.

In addition, for any single technical feature described or implied in the embodiments mentioned herein or any single technical feature shown or implied in individual drawings, the present disclosure still allows for any combination or deletion of these technical features (or equivalents thereof) without any technical obstacle. Therefore, it should be considered that these more embodiments according to the present disclosure are also within the scope recorded in this document. In addition, for the sake of brevity, general items commonly known to those skilled in the art, such as the basic configurations and working principles of the elevator power device, the elevator brake and the PID controller will not be described in greater detail herein.

Firstly, FIG. 3 shows a basic processing flow of an embodiment of a smooth braking control method for an elevator according to the present disclosure. As shown in FIG. 3, by executing these exemplary steps which will be discussed below, the smooth braking control method for an elevator can be realized.

Specifically, in step S11, based on current running characteristics of an elevator car, an analysis and judgment can be made on a current state of the elevator car, so as to determine whether it is currently running in a decelerating state. For the elevator car, its running characteristics may for example include, but are not limited to, a running speed, a running position and the like in an elevator hoistway, which may be detected by one or more sensors (such as a speed sensor, a position sensor, etc.) installed on the elevator car and/or elevator hoistway, a wireless beacon system, etc., or may also be obtained directly for example from an elevator controller, so that the current running state of the elevator car can be determined according to such running characteristics, such as in a decelerating state, an accelerating state, a stationary state, etc. If it is determined after analysis and judgment that the elevator car is in the decelerating state, it indicates that an (emergency) braking operation may be being performed on the elevator car at this time, so the subsequent steps in the embodiment of the smooth braking control method for an elevator can be executed; otherwise, it will indicate that the elevator car is in another state, so it is not necessary to execute the subsequent steps in the embodiment shown in FIG. 3 until it can be determined that the elevator car is now in the decelerating state according to the subsequent running characteristics.

With continued reference to FIG. 3, in step S12, when it is determined that the elevator car is in the decelerating state, the current deceleration of the elevator car can be obtained. It should be understood that the purpose of obtaining the deceleration data of the elevator car is to distinguish whether the elevator car is undergoing a conventional braking operation or an emergency braking operation at this time. Once it is found that the elevator car is undergoing an emergency braking operation, the method of the present disclosure can be used to control the elevator car to achieve a smooth braking operation, thereby effectively alleviating or avoiding the aforementioned many adverse effects and risks caused by the implementation of brake hard stop operation.

As an example, in some embodiments, the current deceleration of the elevator car can be obtained by calculating the running characteristics of the elevator car discussed above. For example, a speed sensor (or a position sensor) may be used to collect the running speed data (or position data) of the elevator car at at least two different moments, and then the data is numerically processed to obtain the deceleration data of the elevator car. Of course, in some other embodiments, the present disclosure also allows the current deceleration of the elevator car to be directly obtained by means of devices such as one or more acceleration sensors installed on the elevator car, that is, data processing that is the same as or similar to the above-mentioned data processing is completed centralizedly in the interior of such acceleration sensors, so the method of the present disclosure can directly use the deceleration data of the elevator car output from the acceleration sensors.

With continued reference to FIG. 3, in step S13, it is judged whether the current deceleration of the elevator car obtained through the above step exceeds a preset value, which may be selected and set according to different application requirements; for example, the specific value may be set to 0.9 g (g is the gravitational acceleration), 0.85 g, 0.8 g, 0.75 g, 0.7 g, 0.65 g, 0.6 g, 0.55 g, 0.5 g, etc.

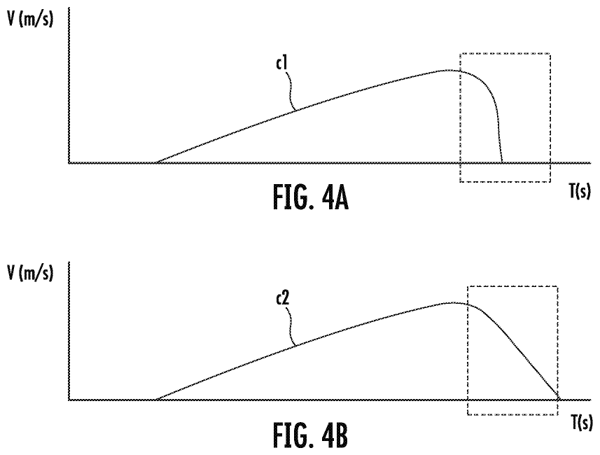

If it is found that the current deceleration of the elevator car exceeds the preset value, it can indicate that the elevator car is performing emergency braking at this time. Therefore, in the subsequent step S14, a magnitude of an electromagnetic force output from an electromagnetic member of the elevator brake can be controlled to reduce the deceleration of the elevator car until it is not larger than the above-mentioned preset value. That is, at this time, by regulating the magnitude of the electromagnetic force in real time, the braking force provided by the elevator brake can be better controlled, so that the severe vibration of the elevator car can be alleviated or avoided to achieve a good effect of smooth braking. As compared with the “brake hard stop” in the prior art, the smooth braking of the present disclosure can be called “brake soft stop”, which is shown exemplarily in FIG. 4 very clearly and intuitively.

Reference is made to FIGS. 4(a) and 4(b), in which FIG. 4 (a) shows a running speed curve c1 of the elevator car when the method of the prior art is used to perform a brake hard stop operation on the elevator car for a certain model of elevator system, and FIG. 4 (b) shows a running speed curve c2 of the elevator car when the embodiment of the smooth braking control method for an elevator according to the present disclosure is used for the above elevator system to perform braking operation on the elevator car.

Through comparison, it can be found that when the elevator car runs after being started, its running speed V will continue to increase, but when it encounters emergency braking, which is shown by dashed-line blocks in both FIGS. 4 (a) and 4 (b) for highlighting, the brake hard stop operation in the prior art leads to an obviously steep descending curve (that is, a large descending slope), which indicates that the running speed of the elevator car has a very large descending fluctuation within a short braking operation time, so there are severe vibrations; however, due to the soft braking operation of the present disclosure, as compared with FIG. 4(a), the part of the curve in the dashed-line box of FIG. 4(b) has a much smoother descending slope, indicating that the soft braking control process is smooth at this time, which can obviously alleviate or even eliminate the severe vibrations that occur during the brake hard stop operation of the elevator car in FIG. 4(a), and has a quite obvious improvement effect on braking control.

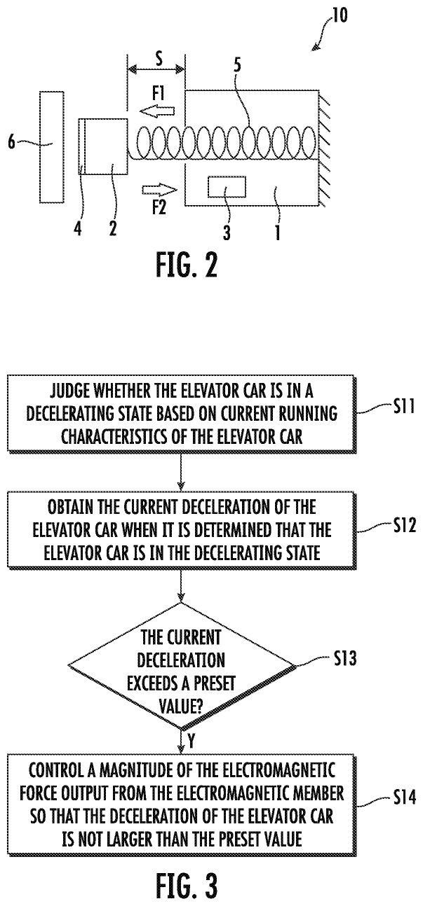

The specific control process in the method of the present disclosure will be described in greater detail below in conjunction with the example of the elevator brake shown in FIG. 2.

Firstly, when the elevator car normally moves up and down in the elevator hoistway, the elevator brake will be in a second state, that is, an electromagnetic member 3 in a fixed part 1 of the elevator brake can be supplied with a conventional operating current or voltage, so that an electromagnetic force F2 is output outward through the electromagnetic member 3. The direction of the electromagnetic force F2 is opposite to the direction of a force F1 applied to a moving part 2 by a component 5 (such as a spring, etc.), and the electromagnetic force F2 can overcome the force F1 to urge the moving part 2 to move in the direction toward the fixed part 1, so that a friction member 4 on the moving part 2 is out of contact with an elevator power device 20, thus allowing the elevator car to move up and down.

Contrary to the above operation, when the elevator brake needs to be placed in a first state (also often referred to as “braking state”), the electromagnetic member 3 can be de-energized to release the electromagnetic force F2 that was originally applied to the moving part 2. At this time, the moving part 2 will be pushed by the force F1 provided by the component 5 to move toward a braking member 6 along a guiding direction of elements and components such as a guide sleeve and a bolt in the elevator brake; then through the contact between the friction member 4 and the braking member 6, a braking force is applied to the braking member 6, thereby prompting the elevator power device (such as a traction machine, etc.) to stop outputting power outwardly, which can realize the braking operation on the elevator car. When the elevator brake is in the first state, there is an air gap S between the fixed part 1 and the moving part 2, which is schematically shown in FIG. 2.

It should be noted that for the above electromagnetic member 3, the present disclosure allows for flexible setting and selections thereof according to actual application requirements in terms of the specific structure, configuration, components, arrangement position and installation method in the elevator brake, etc.; that is, there are no specific restrictions on this. As an exemplary illustration, for example, in some embodiments, one or more winding coils may be selected very conveniently and arranged in a circumferential direction of the fixed part 1. For example, four or six winding coils may be evenly arranged in the circumferential direction of the fixed part 1 at the same time, which not only helps promote outwardly providing and applying the electromagnetic force more evenly, but also provides a certain degree of redundancy at the same time, thereby improving the safety and reliability of the elevator brake. In practical application, by controlling the input signal (such as current, voltage, etc.) of one or more of the winding coils, the magnitude of the electromagnetic force output from the electromagnetic member can be controlled as needed, so as to better work with the force F1 to assist in forming a resultant action for smoothly braking the elevator car.

It should be understood that the above embodiments are only exemplary description. Without departing from the spirit of the present disclosure, those skilled in the art can make more possible settings, changes and adjustments according to different application requirements, to which the present disclosure will impose no restrictions at all.

For example, as an optional situation, in order to further achieve a more ideal smooth braking control effect on the elevator car, it can be considered to set a target deceleration of the elevator car for the entire braking control process; for example, it may be set to be smaller than or equal to the preset value of deceleration of the elevator car mentioned in step S13 above, such as 0.4 g, 0.5 g or any other suitable value. The specific value may be flexibly set according to actual application requirements. In this way, the magnitude of the electromagnetic force provided by the elevator brake can be controlled accordingly, so that the actual deceleration of the elevator car can be basically maintained at the above-mentioned target deceleration, and the entire decelerating and braking process of the elevator car can be controlled to be more stable and have significantly reduced fluctuations, etc.

As an example, in some application occasions, closed-loop control can be used to process a difference between the above-mentioned target deceleration and the obtained current deceleration of the elevator car, and accordingly determine the corresponding input signal (which may for example be in the form of a current signal, a voltage signal, etc.) of the electromagnetic member in the elevator brake, so as to enable the electromagnetic member to output the corresponding electromagnetic force having a desired magnitude after receiving such an input signal, that is, to achieve the purpose of basically maintaining the actual deceleration of the elevator car at the above-mentioned target deceleration.

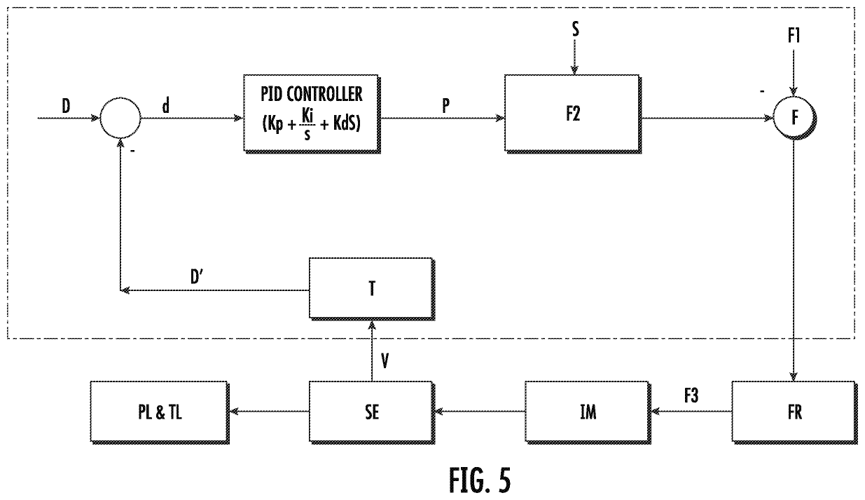

It should be understood that according to the above teachings of the present disclosure, those skilled in the art can apply numerous feasible ways to implement the aforementioned closed-loop control, such as PID control (Proportional Integral Derivative Control), ADRC control (Active Disturbance Rejection Control), and so on. For example, FIG. 5 shows a schematic block diagram of the working principle when PID control is applied in the embodiment of the method according to the present disclosure, and this specific example will be described below.

As shown in FIG. 5, a dashed-line block is used in the figure to mark the corresponding part of the closed-loop control implemented by using PID control in the example of the method of the present disclosure. It should be noted that when implementing PID control in the method of the present disclosure, multiple feasible ways are allowed. For example, only one of P, I and D may be adjusted, or they can be adjusted in combination, such as using PI, PD . . . and other ways, and the present disclosure does not limit the application of actual combinations of P, I and D.

Specifically, in the actual control process, there may still be a certain error between a target deceleration D, which serves as the control target of the elevator car (that is, as a command signal of the PID controller), and the current actual deceleration D′ of the elevator car, and this error is represented by a reference symbol d in FIG. 5. The PID controller can perform closed-loop feedback control based on the above-mentioned target deceleration D and error d, so that the corresponding input signal P can be output and provided to the electromagnetic member in the elevator brake and the desired electromagnetic force F2 (which is also related to the size of the air gap S between the fixed part 1 and the moving part 2) can be generated accordingly. The electromagnetic force F2 will form a resultant force F with the aforementioned force F1. After considering a friction coefficient FR of the friction member in the elevator brake in combination, the above-mentioned resultant force F will finally be formed into a braking force F3 which is then applied to the elevator power device.

For the convenience of comparison and understanding, a reference symbol IM is also used in FIG. 5 to indicate an unbalanced gravity difference existing in the elevator car, which is related to the number and weight of passengers in the elevator car at this time. This kind of unbalanced gravity difference will be considered in the existing hard braking control process, that is, its control process will be affected by the unbalanced gravity difference of the elevator car that actually exists. In contrast to this, as described above, the formation process of the braking force F3 is related to the deceleration control and processing of the elevator car, and is not related to the unbalanced gravity difference of the elevator car. That is to say, when the improved braking force F3 is provided according to the above optimized processing method of the present disclosure, it will not be affected by the use of different types of elevator cars with different passenger loading conditions, so the present disclosure has strong practicality, high processing efficiency, and a wide range of applications.

In addition, the actual running speed V of the elevator car at this time can be obtained by a device such as a speed encoder, which is marked by a reference sign SE in FIG. 5. For the above actual running speed V, a data processing module T can be used to perform corresponding processing (such as differential processing, etc.) to obtain the actual deceleration D′, and then the actual deceleration D′ is used as a feedback signal of the PID controller for the next PID control.

As described above, by performing cyclic feedback processing on the actual deceleration D′ of the elevator car and the target deceleration D, a closed control is formed, so that the actual deceleration of the elevator car can be basically maintained at the target deceleration efficiently, accurately and quickly, which can better ensure the smooth braking operation of the elevator car. It should also be noted that a speed limiter SL and a time limiter TL that are generally required to be used in the existing elevator safety design are simultaneously shown in FIG. 5, and both or any of them can be used in the method of the present disclosure without causing any restrictions.

For another example, as an optional situation, it can be considered to limit the input signal to a preset range before inputting the input signal determined by the closed-loop control to the electromagnetic member in the elevator brake, so as to further achieve the goals of effectively controlling the smooth braking, enhancing system safety, etc. For example, a current limiter or a voltage limiter and other corresponding limiting devices can be optionally added behind an output terminal of the PID controller shown in FIG. 5 to avoid undesired relatively excessive electromagnetic force generated by possible transmission of relatively large current, voltage and other control signals to the electromagnetic member in the elevator brake.

For another example, as an optional situation, after step S14 is executed, report information related the obtained deceleration data of the elevator car may be output outwardly; for example, such report information may be stored locally in the elevator or stored in a cloud server, and/or such report information may be sent to a user end (such as a mobile phone, a PAD and other mobile communication terminals), etc., so that elevator operation management personnel, device maintenance personnel, device manufacturers or parts suppliers and the like can be informed in time, thereby playing a role of safety precaution, timely warning, etc. As a result, it is possible to further make full use of the relevant data information obtained from the smooth braking operations of the elevator car that have been performed.

It can be understood that those skilled in the art can make flexible settings on the specific content, expression form, transmission path, level, etc., of the report information according to actual requirements. Obtaining and analyzing the corresponding data in such report information will help better grasp work and performance state and other information of devices such as the elevator brake, the elevator power device and/or the elevator car currently in use, thereby promoting device maintenance, safety assurance, system improvement, etc.

In addition, as another aspect that is significantly superior to the prior art, the present disclosure also provides a smooth braking control device for an elevator, which is provided with a controller for executing corresponding steps of the method according to the present disclosure discussed above for example. The smooth braking control device for an elevator can be manufactured and sold separately.

It can be understood that according to the disclosure of the present application, those skilled in the art may use, for example, processors, electronic circuits, integrated circuits (ASICs) and/or memories and combinational logic circuits for executing one or more software or firmware programs, and any other suitable elements and components to realize the above-mentioned controller in the smooth braking control device for an elevator. In addition, any other suitable elements and components, units, modules, or devices, such as field effect transistors, may be added to achieve more controls. For example, MOS-FETs and the like may be used to provide variable input current control for the electromagnetic member.

In addition, since the technical contents of the elevator brake, various specific steps of the smooth braking control for an elevator, the input signal of the electromagnetic member and its implementation, and the processing of report information have been described in great detail in the foregoing, the corresponding functions of the controller in the smooth braking control device for an elevator can be realized by directly referring to the specific description of the above corresponding parts, which will not be repeated herein.

In addition, according to the technical solution of the present disclosure, an elevator brake is also provided. Specifically, the elevator brake may be equipped with the smooth braking control device for an elevator designed and provided according to the present disclosure, which can effectively alleviate or eliminate the defects and problems in existing hard braking of the elevator car, realize smooth braking control of the elevator car, enhance people's safety in taking the elevator, avoid undesired injury accidents due to emergency stop operation of the elevator car, and help improve the working performance of the existing elevator brakes, thereby achieving these significant technical advantages mentioned above. Therefore, the present disclosure has high practical value.

The smooth braking control method for an elevator, the smooth braking control device for an elevator, and the elevator brake according to the present disclosure have been elaborated above in detail by way of example only. These examples are merely used to illustrate the principles and embodiments of the present disclosure, rather than limiting the present disclosure. Various modifications and improvements can be made by those skilled in the art without departing from the spirit and scope of the present disclosure. Therefore, all equivalent technical solutions should fall within the scope of the present disclosure and be defined by the claims of the present disclosure.

What is claimed:

1. A smooth braking control method for an elevator, wherein the elevator is provided with an elevator brake comprising a fixed part and a moving part, and in a first state, by driving the moving part to move toward an elevator power device so that a friction member in the moving part contacts the elevator power device, the elevator brake provides a braking force to stop an elevator car, and in a second state, by outputting an electromagnetic force from an electromagnetic member in the fixed part, the friction member is disengaged from the contact with the elevator power device, the smooth braking control method for the elevator comprising:
judging whether the elevator car is in a decelerating state according to current running characteristics of the elevator car;
obtaining a current deceleration of the elevator car if it is determined that the elevator car is in the decelerating state; and
judging whether the obtained current deceleration exceeds a preset value, and controlling a magnitude of the electromagnetic force output from the electromagnetic member if the obtained current deceleration exceeds the preset value, so that the deceleration of the elevator car is not larger than the preset value.

2. The smooth braking control method for the elevator according to claim 1, further comprising:
setting a target deceleration of the elevator car, and controlling the magnitude of the electromagnetic force so that the deceleration of the elevator car is substantially maintained at the target deceleration, the target deceleration being no larger than the preset value.

3. The smooth braking control method for the elevator according to claim 2, wherein an input signal of the electromagnetic member is determined through closed-loop control based on a difference between the target deceleration and the obtained current deceleration of the elevator car, so that the electromagnetic member outputs the electromagnetic force of a corresponding magnitude according to the input signal.

4. The smooth braking control method for the elevator according to claim 3, further comprising:
limiting the input signal within a preset range, before the input signal determined through the closed-loop control is input to the electromagnetic member.

5. The smooth braking control method for the elevator according to claim 3, wherein the closed-loop control comprises PID control, and at least one of P, I, and D in the PID control is adjusted, and wherein a feedback signal in the PID control is a deceleration obtained by performing differential processing on a running speed of the elevator car, a command signal is the target deceleration, and the input signal comprises a current signal and a voltage signal.

6. The smooth braking control method for the elevator according to claim 1, wherein the electromagnetic member is one or more winding coils arranged in a circumferential direction of the fixed part, and the magnitude of the electromagnetic force output from the electromagnetic member is controlled by controlling an input current or an input voltage of at least one of the winding coils.

7. The smooth braking control method for the elevator according to claim 1, further comprising:
storing report information locally in the elevator or in a cloud server and/or sending the report information to a user end, the report information at least comprising the obtained deceleration data of the elevator car, and the user end comprising a mobile communication terminal of a user.

8. A smooth braking control device for an elevator, wherein the elevator is provided with an elevator brake comprising a fixed part and a moving part, and in a first state, by driving the moving part to move toward an elevator power device so that a friction member in the moving part contacts the elevator power device, the elevator brake provides a braking force to stop an elevator car, and in a second state, by outputting an electromagnetic force from an electromagnetic member in the fixed part, the friction member is disengaged from the contact with the elevator power device, the smooth braking control device for the elevator comprising a controller which is configured to execute:
judging whether the elevator car is in a decelerating state according to current running characteristics of the elevator car;
obtaining a current deceleration of the elevator car if it is determined that the elevator car is in the decelerating state; and
judging whether the obtained current deceleration exceeds a preset value, and controlling a magnitude of the electromagnetic force output from the electromagnetic member if the obtained current deceleration exceeds the preset value, so that the deceleration of the elevator car is not larger than the preset value.

9. The smooth braking control device for the elevator according to claim 8, wherein the controller is further configured to execute:
according to a set target deceleration of the elevator car, controlling the magnitude of the electromagnetic force so that the deceleration of the elevator car is substantially maintained at the target deceleration, the target deceleration being no larger than the preset value.

10. The smooth braking control device for the elevator according to claim 9, wherein the controller is configured to: determine an input signal of the electromagnetic member through closed-loop control based on a difference between the target deceleration and the obtained current deceleration of the elevator car, so that the electromagnetic member outputs the electromagnetic force of a corresponding magnitude according to the input signal.

11. The smooth braking control device for the elevator according to claim 10, wherein the controller is further configured to execute:
limiting the input signal within a preset range, before the input signal determined through the closed-loop control is input to the electromagnetic member.

12. The smooth braking control device for the elevator according to claim 10, wherein the closed-loop control comprises PID control, and at least one of P, I, and D in the PID control is adjusted, and wherein a feedback signal in the PID control is a deceleration obtained by performing differential processing on a running speed of the elevator car, a command signal is the target deceleration, and the input signal comprises a current signal and a voltage signal.

13. The smooth braking control device for the elevator according to claim 8, wherein the electromagnetic member is one or more winding coils arranged in a circumferential direction of the fixed part, and the controller is configured to: control the magnitude of the electromagnetic force output from the electromagnetic member by controlling an input current or an input voltage of at least one of the winding coils.

14. The smooth braking control device for the elevator according to claim 8, wherein the controller is further configured to execute:
storing report information locally in the elevator or in a cloud server and/or sending the report information to a user end, the report information at least comprising the obtained deceleration data of the elevator car, and the user end comprising a mobile communication terminal of a user.

15. An elevator brake, which is configured with the smooth braking control device for the elevator according to claim 8.
